(19) United States
(12) Patent Application Publication
(10) Pub. No.: US 2017/0190477 A1
(43) Pub. Date: Jul. 6, 2017

(54) RECLOSABLE CONTAINER AND METHOD OF MANUFACTURE

(71) Applicant: Jonathan Hui, Hong Kong (CN)

(72) Inventor: Jonathan Hui, Hong Kong (CN)

(21) Appl. No.: 15/463,505

(22) Filed: Mar. 20, 2017

Related U.S. Application Data
(63) Continuation-in-part of application No. 13/283,366, filed on Oct. 27, 2011, now abandoned.
Application No. 13/283,366 is a division of application No. 11/263,607, filed on Oct. 31, 2005, now Pat. No. 8,096,022.

(51) Int. Cl. B65D 33/25; B29C 47/00

(52) U.S. Cl. CPC B65D 33/2591; B29C 47/0026; B29C 47/0064; B29C 47/0066; B29L 2031/7128

(57) ABSTRACT

A reclosable bag has first and second walls and an open top defined by first and second elongate flexible fastener strips adjacent the top of the walls. One fastener strip has a profile portion forming a groove and a portion forming a rib. A portion of the rib is received and retained in the groove when the bag top is closed. Each fastener strip has a base connected to the respective wall. A slider is mounted on the strips and movable in one direction to open the bag, and in the opposite direction to close the bag. A separator, located in the slider, extends downwardly into the space between the top of the slider and the upper edges of the fastener strips. A pair of flanges extend outwardly from the bag walls, one on each wall. The flanges are disposed parallel to the top of the walls, and substantially below the fastener strips, the flanges being sized, constructed and arranged for retention within the slider.

### CROSS-REFERENCE TO RELATED APPLICATIONS

The present disclosure is a continuation in part of U.S. patent application Ser. No. 13/283,366, entitled “RECLOSABLE CONTAINER AND METHOD OF MANUFACTURE” filed on Oct. 27, 2011, which claims priority to U.S. Pat. No. 8,096,022 entitled “RECLOSABLE CONTAINER AND METHOD OF MANUFACTURE” filed on Oct. 31, 2005, both of which are incorporated by reference herein in their entirety.

### BRIEF DESCRIPTION OF THE DRAWINGS

FIG. 1 of the drawings is a vertical section of the reclosable fastener profile of the present invention, partially broken away, showing male and female profiles, and guide ribs disposed on the outer walls of the reclosable bag.

FIG. 2 of the drawings is a top view of the slider of the present invention.

FIG. 3 of the drawings is a bottom view of the slider of the present invention.

FIG. 4 of the drawings is a front cutaway view of the slider of FIGS. 2 and 3 showing a separator extending downwardly from the top surface thereof.

FIG. 5 of the drawings is a rear cutaway view of the slider of FIGS. 2-4.

FIG. 6 of the drawings is a vertical section taken along the lines BB of FIG. 3 showing the internal configuration of the slider of FIGS. 2-5.

FIG. 7 of the drawings is a front perspective view of the reclosable container of FIG. 1.

FIG. 8 of the drawings is a front view of the apparatus for extruding thermoplastic film having fastener profiles integrally formed therein.

FIG. 9 of the drawings is a front perspective view of a portion of the die used for manufacturing a male profile in the fastener strips of FIG. 1.

FIG. 10 of the drawings is a front perspective view of one portion of the die used to show the female fastener strips in FIG. 1 of the drawings.

FIG. 11 of the drawings is a vertical section of the male and female profiles of FIG. 1 extending from the bag walls, with the slider disposed on the fastener and held in place by the bottom track extending laterally from the bag walls, as well as the separator extending between the male and female profiles.

FIG. 12 of the drawings is a vertical section of the bag and fastener strip of FIG. 11 showing in particular the male and female profiles interlocked and the slider affixed to the fastener strip by the bottom tracks.

FIG. 13 of the drawings is a vertical section of an extrusion die in an exploded view separated into two parts used for manufacturing a tube of thermoplastic film having reclosable fastener profile strips integrally formed thereon and tracks on the exterior of the film.

FIG. 14 of the drawings is a schematic diagram showing converting of the plastic film manufactured in FIG. 8 into reclosable bags utilizing a conventional bag making machine having a slider application device thereon.

FIG. 15 of the drawings is a vertical section of the male and female profiles of FIG. 1 extending from the bag walls, with the slider disposed on the fastener and held in place by the bottom track extending laterally from the bag walls, as well as the separator extending between the male and female profiles.

The foregoing description of drawings merely explain and illustrate the invention and the invention is not limited thereto, except insofar as those who have the disclosure before them are able to make modifications and variations therein without departing from the invention.

### DETAILED DESCRIPTION OF THE DISCLOSURE

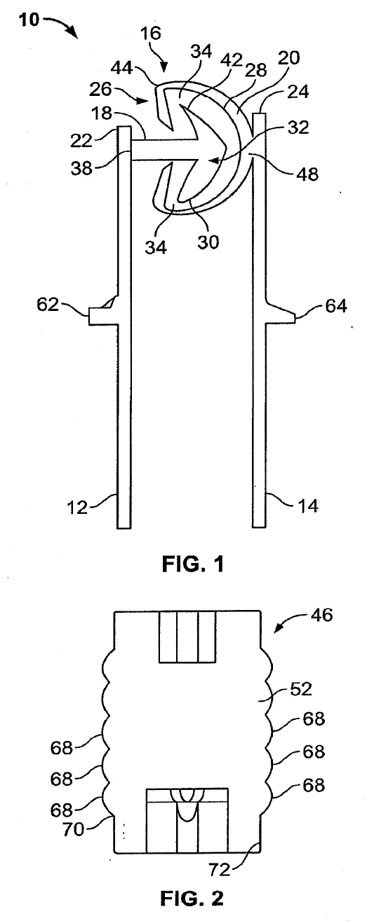

As shown in FIG. 1 of the drawings, a reclosable bag 10 having first and second walls 12 and 14 and an open top 16 is defined by first and second elongate flexible fastener strips 18 and 20 attached to the first and second walls 12 and 14, respectively, adjacent the top 22 and 24 of the walls. One of the fastener strips 20 has a profile portion 26 which forms a groove 28. The other fastener strip 18 has a profile portion 30 forming a rib 32 with a portion of the rib 34 received and retained within the groove 28 when the bag 36 is closed. Each of the strips 18 and 20 has a base 38 and 48 connected to the respective walls 22 and 24 and each of the strips 18 and 20 further has an upper edge 42 and 44 adjacent the upper edge of the other strip 18 and 20 respectively.

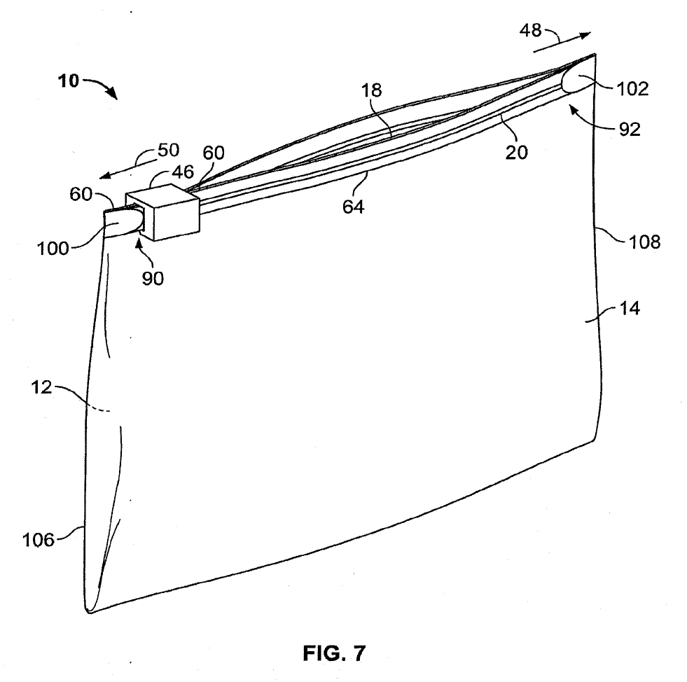

As shown in FIG. 7, Bag 10 has a slider 46 mounted on the strips 18 and 20 and moveable in one direction 48 longitudinally of the strips 18 to 20 to progressively separate the rib 34 from the groove 28 to open the bag 10. Slider 46, being moveable in the opposite direction 50, progressively returns the rib 32 portion to retain condition in the groove 28 to close the bag.

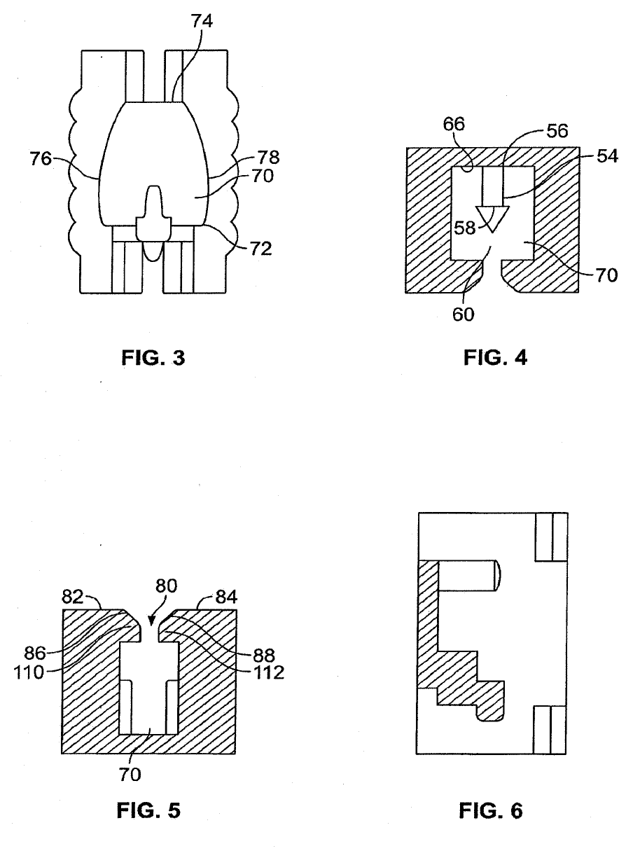

As shown in FIGS. 1-6, the slider 46 further has a top 52. The slider 46 further has a separator 54 situated therein having a proximal portion 56 attached to the top 52 of the slider 46 and extending downwardly therefrom and having a distal portion 58 residing in a first space 60 between the top of the slider and the upper edges of the groove 28 when the rib portion 32 is retained in the groove 28 of the profile. The separator 54 has an arrow-shaped tip 60 constructed and arranged, i.e., positioned and sized to facilitate selective separation of the rib 32 from the groove 28.

In the preferred embodiment the separator has a length of 2.3 mm±0.3 mm. The separator 54 is preferably integrally formed from the slider 46 and is made of one homogeneous unit of plastic, preferably injection molded POM Acetal sold by RTP Company, Winona, Minn., or polypropylene with additive for lubrication.

In the preferred embodiment the slider is constructed of polyethylene, polycarbonate, polystyrene, acrylonitrile butadiene styrene or other commonly formed injection molded plastic pieces.

As a further feature of the invention as shown in FIG. 1, the outside walls 12, 14 have a pair of flanges 62 and 64 or tracks extending outwardly from the outside walls and running parallel to the upper edges 22, 24 of the walls and to the fastener strips 18 and 20 but spaced separately therefrom and substantially below said fastener strips 18 and 20. By separately from and substantially below the fastener strips 18 and 20 it is meant that the flanges 62 and 64 extend from the bags walls 22 and 24, not from the fastener strips 18 and 20 themselves. The flanges 62 and 64 are sized for telescopic reception in slider 46, as will be further described herein. It should be noted in this regard that by having the flanges 62 and 64 on the outside walls 12 and 14 of the bag 10, and substantially below the fastener strips 18 and 20, the slider 46 grips the fastener strips 18 and 20 more firmly. The slider 46 holds the fastener strips 18 and 20 from below and therefor locks them in place and prevents the slider from disengaging from the fastener strips 18.20. This is an improvement from prior art fastener strips having rounded bumps on their exterior which serve only to guide the fastener strips, but do not help to retain them in place or prevent disengagement.

As seen in FIGS. 2-6, slider 46 has a top portion 52. Extending downwardly from top portion 52, as is seen in FIG. 4, is a separator 54 having a distal portion 58. The distal portion 58 of separator 54 has an arrowhead shaped tip 60 mounted thereon. The arrowhead has an angle of 60°±10° which is to facilitate opening of groove 28 of profile portion 26 with rib 32 profile portion 30 as contained therein.

In the preferred embodiment, top portion 52 of slider 46 is approximately 1.2 mm in thickness. The distal portion 58 extends approximately 2.3 mm from the inside surface 66 of top 52. Slider 46 preferably has a height of approximately 8.6 mm, a thickness at its ends of 1.15 mm, a length of 14.8 mm, and the arrowhead shaped tip 60 of a height of approximately 1 mm.

In the preferred embodiment, slider 46 has a series of gripping ribs 68 which were vertically disposed along its lateral edges 70 and 72, respectively. These gripping ribs 68 in the preferred embodiment have a radius of approximately 1.25 mm.

In the preferred embodiment, slider 46 has an interior chamber 70 having vertical walls at the front and rear ends 72 and 74, and having curved sidewalls 76 and 78 which have a radius of 9.9 mm.

As best seen in FIG. 5, slider 46 has a centrally disposed gap 80. Gap 80 in the preferred embodiment is 1.15 mm in width. The left and right bottom surfaces 82 and 84 are approximately 2.5 mm in width having beveled surface 86 and 88. Beveled surfaces 86 and 88 are approximately 0.8 mm and are beveled at an angle of 45° relative to the left bottom surface 82 and right bottom surface 84. Gap 80 is designed to receive rib 32 and to retain rib 32 within chamber 70.

In addition, as seen in FIG. 7, chamber 70 is also designed to receive exterior flanges 62 and 64 which are retained within chamber 70 so as to retain slider 46 on fastener strips 18 and 20. In the preferred embodiment, a force of at least three pounds and preferably 5 pounds is required to remove slider 46 from fastener strips 18 and 20.

As further seen in FIG. 7, slider 46 has a first travel and stop position 90 where the bag 10 is in the closed position and the fastener strips 18 and 10 are interlocked and a second travel and stop position 92 in which fastener strips 18 and 20 are separated from each other to allow dispensing of product from bag 10 or insertion of product therein.

As further seen in FIG. 7, the proximal and distal ends 100 and 102 are fastener strips 18 and 20 and are ultrasonically sealed to each other and to bag walls 12 and 14, proximate the lateral edges 106 and 108 of bag 10. The ultrasonic seal is to prevent the fastener strips 18 and 20 from opening, and to prevent the bag 10 from being torn when the fastener strips 18 and 20 are open.

Returning to FIG. 4, within slider 46 are inwardly facing channels 108 and 110 which are sized and positioned for slidable reception of flanges 62 and 64 and for retention of flanges 62 and 64 in slot or gap 82. On the bottom of slider 46 are a pair of inwardly facing shoulder members 110 and 112 with gap 80 therebetween. Shoulder members 110 and 112 have beveled surfaces 86 and 88 thereon for guiding fastener strips 18 and 20 into said gap 82.

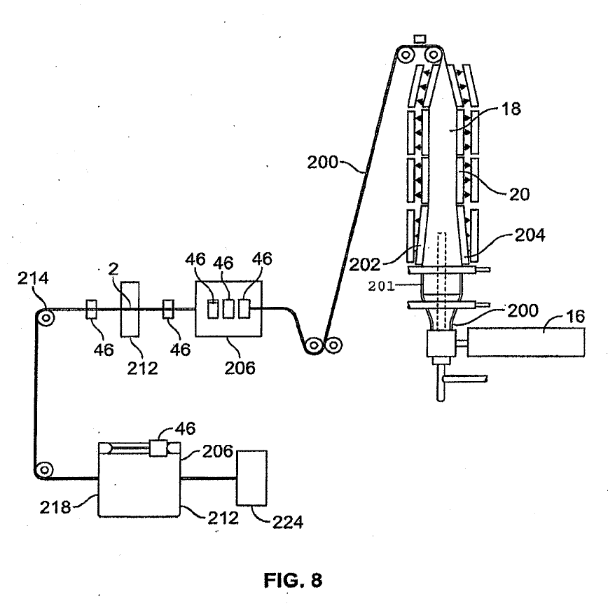

The present invention further includes a method of manufacture of reclosable bags. As seen in FIG. 8, the length of thermoplastic film 200 is extruded as a tube 201. Tube 201 is slit between male and female profiles 26 and 30 so as to form opposed longitudinal edges 202 and 204. Simultaneously, a pair of fastener strips 18 and 20 are extruded on longitudinal edges 202 and 204, respectively, as well as flange 62 and 74. Film 200 is preferably a low density polyethylene such as Exion 316 having a thickness of 4 mm. Film 200 may also be laminated to other materials such as foil, nylon, or other commonly known laminating materials.

Film 200 and fastener strips 18 and 20 are cooled. Sliders, such as slider 46, may be applied at spaced intervals to fastener strips 18 and 20 by slider dispenser 206. Each of the fastener strips has either a male or female profile for interlocking with the other. Once the sliders attach to the fastener strips, the film 200 is cross-sealed at location 212 to form the first side 206 of a bag 10. A second cross-seal 214 is sealed on a bag tube 216 to form a second side 218 of bag 10, so as to capture a single slider 46 between the first and second sides 206 and 218 of bag 210. A spot seal 219 such as those found by an ultrasonic sealing may be used to seal the ends 100 and 102 of the fastener strips 18 and 20 on each bag 14 (FIG. 7).

Bag 210 is then cut from the film tube 216 by means of a hot wire or knife 224. A finished bag 10 is thus provided with a reclosable fastener 230 and a slider 46 for opening and closing the bag 210.

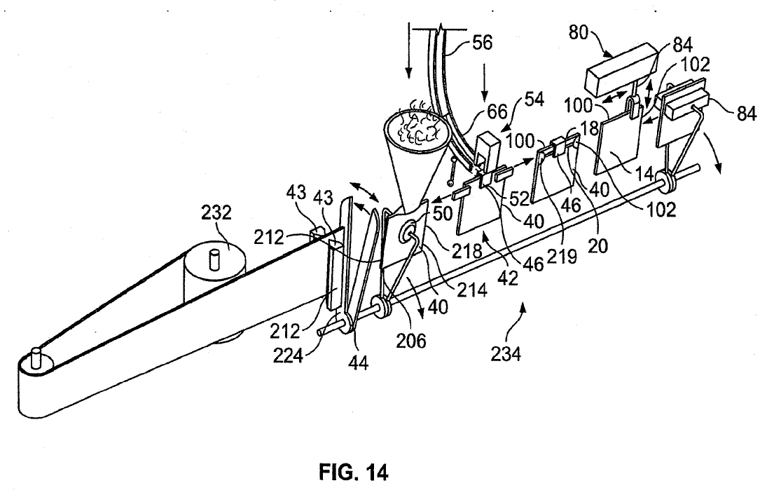

Alternatively, as seen in FIG. 14, tube 201 may be cooled and then wound onto a roll 232. Roll 232 may then be shipped to the user who has a bag making machine 234. Roll 232 may then be intermittently unwound from roll 232 and sliders 46 applied at spaced intervals. Cross seals 212 may then be formed across bag tube 216. A second cross-seal 214 is sealed on a bag tube 216 to form a second side 218 of bag 10, so as to capture a single slider 46 between the first and second sides 206 and 218 of bag 210. A spot seal 219 such as those found by an ultrasonic sealing may be used to seal the ends 100 and 102 of the fastener strips 18 and 20 on each bag 14 (FIG. 7).

Bag 210 is then cut from the film tube 216 by means of a hot wire or knife 224. A finished bag 10 is thus provided with a reclosable fastener 230 and a slider 46 for opening and closing the bag 210.

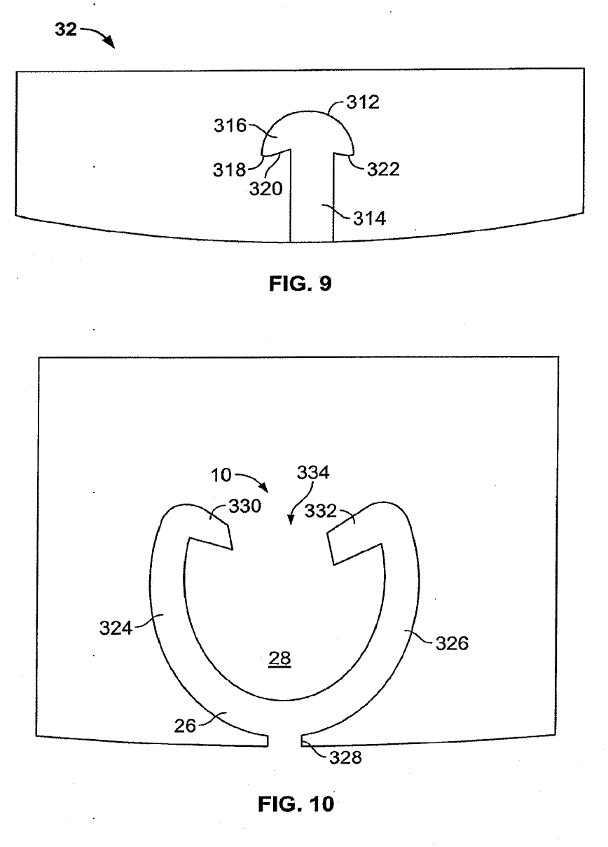

As seen in FIG. 13 of the drawings, an extrusion die 300 for blown film (not shown) is shown in a split configuration, but as is known by those in the art, the die would be formed as a circular tube through which thermoplastic, such as polyethylene, film is extruded. As further seen in FIG. 13, a gap or first aperture 302 for forming a rib 32 in the configuration shown in FIG. 9 is disclosed. A second aperture 304 is formed in die 300 in the configuration of the female profile or groove 28 as best seen in FIG. 10. Molten thermoplastic film (not shown) is extruded through die opening 306 so as to form a tube of film which solidifies upon exposure to the air and is cooled to form a tube of plastic film as described infra relative to FIG. 8 on page 6. On either side of first aperture 302 and second aperture 304 are third and fourth apertures 308 and 310 formed in a configuration of ribs or tracks 62 and 64, best seen in FIG. 1. Thus, when film is extruded from die 300, ribs 62 and 64 are formed on the outside of the film which later forms the bag walls 12 and 14. Male profile 18 and female profile 24 are formed on the inside of bag walls 12 and 14. This simultaneous extrusion of both the fasteners and the ribs facilitates manufacturing speed, reduces cost, and produces a uniform quality product.

As seen in FIG. 13 of the drawings, first aperture 302 of die 300 has a height of 8.5 centimeters and a mushroom shaped configuration. The mushroom shaped head 312 of the mushroom is approximately 2.5 centimeters in thickness, and the width of the shaft 314 is approximately 1.5 centimeters on the right side and approximately 1 centimeter on the left side. In order to make it more difficult for bag 10 to be opened by the force of product within the bag, fastener 18 is constructed to provide what is called differential opening force, i.e., the force required to open from the outside of the bag is easier than that required from the inside of the bag. In this regard, mushroom shaped head 312 has a larger portion 316 having a lip or rim 318 having a barb or hook shape 320 which is at a greater angle and, therefore, more difficult to open than the less angled barb 322 on the opposite side of the mushroom shaped head 312. In the preferred embodiment, mushroom shaped head 312 has a radius of 2.8 centimeters.

Similarly, as shown in FIG. 10, profile portion 26 has a groove 28. Groove 28 is formed from a pair of arms 324 and 326 which extend upwardly from base 328. Corresponding apertures in mold 304 are shown in FIG. 10. In the preferred embodiment groove 28 has a pair of barbed members 330 and 332 extending inwardly and downwardly with a gap 334 extending there between sized for reception of male profile 32. Barbs 330 and 332 are sized, constructed and arranged for interlocking with hooks 318 and 322 when male profile 32 is telescopically inserted into groove 28. Groove 28 and fastener 10 must be sufficiently flexible to allow barbs 318 and 322 as well as fastener 32 to be inserted therein. Consequently, arms 324 and 328 are sufficiently flexible to allow such insertion, but are sufficiently stiff to retain male fastener profile 32 within groove 28 when interlocked with barbs 330 and 332. Similarly, when it is decided to remove male fastener 32 from groove 28, arms 324 and 326 are sufficiently flexible to allow such removal. It should be noted in this regard that barb 32 is larger in size and has a greater downward angle than barb 330 so as to make it more difficult for product within bag 10 to force fastener 16 open.

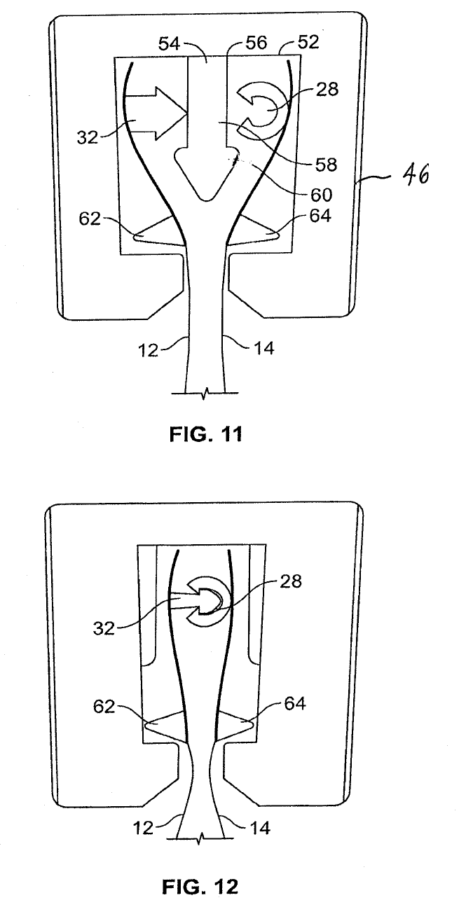

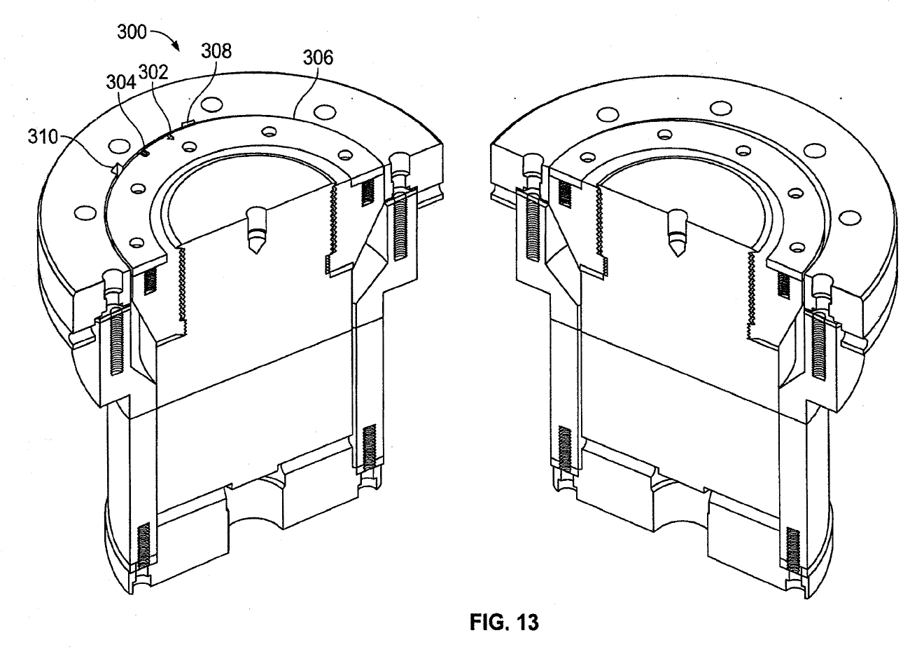

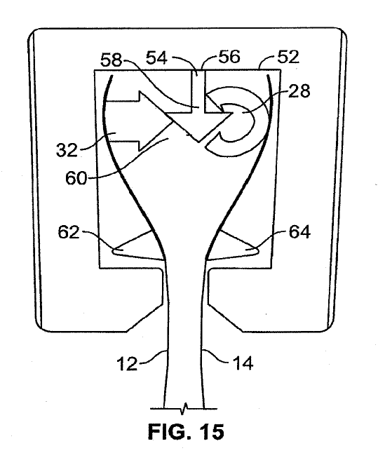

As best seen in FIGS. 11, 12 and 15 of the drawings, tracks or ribs 62 and 64 are formed on the exterior walls of 12 and 14 of bag 10. Bag 10, of course, is formed from the previously mentioned tube of thermoplastic film which is extruded through die 300. As further seen in FIG. 11, separator 54 has a length of 2.3 millimeters±0.3 millimeters. Slider 46 has its proximal portion 56 of separator 54 attached to the top 52 of the interior surface of the slider 46 and has a distal portion 58 residing in a first space 60 within slider 46.

1. A bag closure assembly comprising:
a bag having a bag opening;
first and second elongate flexible strips securable to marginal portions of [a] said bag opening, one of the strips having a profile portion forming a groove and the other strip having a profile portion forming a rib with a portion received and retained in the groove to hold the strips together, each of the strips having an upper edge adjacent the upper edge of the other strip;
a slider mounted on the strips and movable in one direction longitudinally of the strips to progressively separate the rib from the groove to separate the strips, and the slider being movable in the opposite direction to progressively return the rib portion to retained condition in the groove to join the strips;
said bag having first and second bag walls, said first flexible strip being sealed to said first bag wall proximate said bag opening and said second flexible strip being sealed to said second bag wall proximate said bag opening, said first and second flexible strips being parallel to each other;
a pair of flanges disposed on the exterior of said bag walls and turned outwardly from said bag walls, each of said flanges being disposed parallel to said flexible strips but spaced separately therefrom, and substantially below said flexible strips, said flanges being sized, constructed and arranged for retention within the slider.

2. The reclosable bag of claim 1 wherein the proximal and distal ends of each of said fastener strips are ultrasonically sealed to each other and to said bag walls proximate the lateral edge of said bag.

3. The reclosable bag of claim 1 wherein said slider has a pair of inwardly facing channels so as to form a slot for slidable reception of said flanges and for retention of said flanges within said slot.

4. The reclosable bag of claim 3 wherein said channels have oppositely disposed inwardly facing shoulder members having a gap therebetween, said shoulder members being disposed on the bottom of said channels.

5. The reclosable bag of claim 4 wherein said shoulder members each have a beveled surface positioned to guide said fastener into said gap.

6. The reclosable bag of claim 1 wherein said flanges are substantially rectangular in shape.

7. The reclosable bag of claim 1 wherein each of said walls of said bag has a single one of said flanges extending from said wall.
